(19) United States
(12) Patent Application Publication
(10) Pub. No.: US 2025/0005784 A1
(43) Pub. Date: Jan. 2, 2025

(54) METHOD, APPARATUS, ELECTRONIC DEVICE AND STORAGE MEDIUM OF POSE PREDICTION

(71) Applicant: Beijing Zitiao Network Technology Co., Ltd., Beijing (CN)

(72) Inventors: Tao Liu, Beijing (CN); Panwang Pan, Beijing (CN); Peng Dai, Beijing (CN); Yang Zhang, Beijing (CN)

(21) Appl. No.: 18/757,950

(22) Filed: Jun. 28, 2024

(30) Foreign Application Priority Data
Jun. 30, 2023 (CN) 202310801137.6

(51) Int. Cl. G06T 7/70

(52) U.S. Cl. CPC G06T 7/70; G06T 2207/20084

(57) ABSTRACT

Embodiments of the disclosure provide a method, an apparatus, an electronic device, and a storage medium of pose prediction. The method includes: extracting temporal information of input data through a long short-term memory network, the temporal information including recent memory data, and the input data including pose data of a current frame of a target object collected by a pose sensor; generating first intermediate data by fully connecting and activation mapping the input data through a nonlinear learning unit; generating second intermediate data by stacking the recent memory data and the first intermediate data of the nonlinear learning unit through a stacked unit, the long short-term memory network, the nonlinear learning unit, and the stacked unit forming a basic learning module; and predicting a current pose of the target object based on the second intermediate data.

### CROSS-REFERENCE

This application claims priority to Chinese Patent Application No. 202310801137.6 filed on Jun. 30, 2023, and entitled “METHOD, APPARATUS, ELECTRONIC DEVICE AND STORAGE MEDIUM OF POSE PREDICTION”, which is incorporated herein by reference in its entirety.

### FIELD

The present application pertains to the field of motion capture, particularly to a method, an apparatus, an electronic device, and a computer-readable storage medium of pose prediction.

### BACKGROUND

Motion capture technology refers to the use of certain sensors, such as inertial measurement units (IMU), cameras, etc., to capture real-time pose related information of target objects in natural scenes. Based on the captured pose related information, virtual images in virtual scenes may be driven, or behavior analysis in natural scenes may be carried out.

However, traditional deep learning models that implement action capture often use deep models containing temporal structures. When combined with specific heterogeneous hardware, the complexity of the model structure often leads to the need to adaptively adjust the model based on specific heterogeneous hardware platforms, resulting in high deployment costs and difficulty in universal deployment.

### SUMMARY

The present application provides a method of pose prediction, an apparatus of pose prediction, an electronic device, and a computer-readable storage medium.

In an embodiment, the present application provides a method of pose prediction, including: extracting temporal information of input data through a long short-term memory network, the temporal information including recent memory data, and the input data including pose data of a current frame of a target object collected by a pose sensor; generating first intermediate data by fully connecting and activation mapping the input data through a nonlinear learning unit; generating second intermediate data by stacking the recent memory data and the first intermediate data of the nonlinear learning unit through a stacked unit, the long short-term memory network, the nonlinear learning unit, and the stacked unit forming a basic learning module; and predicting a current pose of the target object based on the second intermediate data.

In an embodiment, the present application provides an apparatus of pose prediction, including: an extraction module, a learning module, a stacking module, and a prediction module. The extraction module is configured to extract temporal information of input data through a long short-term memory network, the temporal information including recent memory data, and the input data including pose data of a current frame of a target object collected by a pose sensor; the learning module is configured to generate first intermediate data by fully connecting and activation mapping the input data through a nonlinear learning unit; the stacking module is configured to generate second intermediate data by stacking the recent memory data and the first intermediate data of the nonlinear learning unit through a stacked unit, the long short-term memory network, the nonlinear learning unit, and the stacked unit forming a basic learning module; and the prediction module is configured to predict a current pose of the target object based on the second intermediate data.

In an embodiment, the present application provides an electronic device including a memory, a processor, and a computer program stored in the memory and capable of running on the processor, the processor, when executing the program, implementing the method of pose prediction as described above.

In an embodiment, the present application provides a computer-readable storage medium including a computer program which, when executed by a processor, implements the method as described above.

In summary, in the embodiments of the present application, the long short-term memory (LSTM) network is used to extract temporal information from the input data. The input data not only includes the pose data of the current frame of the target object collected by the pose sensor, but may also include the recent memory data and/or long-term memory data extracted from the previous frame. Afterwards, the recent memory data in the current frame is stacked with the first intermediate data learned by the nonlinear learning unit in the input data to obtain the second intermediate data used to predict the current pose. Due to the consideration of temporal information when predicting the current pose of the target object, it is beneficial to improve the accuracy of current pose prediction. Moreover, due to the fact that the nonlinear learning unit processes input data through full connection and activating mapping, which only require matrix multiplication and/or addition, the nonlinear learning unit may adapt to any heterogeneous hardware platform. Combining the LSTM and nonlinear learning unit, which are widely used, to perform current pose prediction, not only ensures the accuracy of current pose prediction, but also makes the model more adaptable to different heterogeneous hardware platforms, without the need to adjust the model according to specific heterogeneous hardware platforms, resulting in lower deployment costs and the ability of universal deployment.

In addition, compared to models that combine a plurality of LSTMs, which are difficult to execute in parallel, the nonlinear learning unit of the present application may compute with LSTM in parallel, fully using heterogeneous hardware platforms with high parallelism to achieve data processing and improve the prediction efficiency of the model.

The additional aspects and advantages of the embodiments of the present application will be partially provided in the following description, which will become apparent from the following description, or will be learned through the practice of the embodiments of the present application.

### BRIEF DESCRIPTION OF THE DRAWINGS

In order to provide a clearer explanation of the technical solution in the embodiments of the present application, a brief introduction will be given below to the accompanying drawings required for the description of embodiments. It is evident that the accompanying drawings are only some embodiments of the present application. For those skilled in the art, other accompanying drawings may be obtained based on these drawings without creative labor.

FIG. 1 is a schematic diagram of an application scenario of method of pose prediction a method of pose prediction provided by the embodiments of the present application;

FIG. 2 is a flowchart of a method of pose prediction provided by the embodiments of the present application;

FIG. 3 is a structural schematic diagram of a pose prediction model provided by the embodiments of the present application;

FIG. 4 is a flowchart of a method of pose prediction provided by the embodiments of the present application;

FIG. 5 is a flowchart of a method of pose prediction provided by the embodiments of the present application;

FIG. 6 is a structural schematic diagram of a pose prediction model provided by the embodiments of the present application;

FIG. 7 is a flowchart of a method of pose prediction provided by the embodiments of the present application;

FIG. 8 is a structural schematic diagram of a pose prediction model provided by the embodiments of the present application;

FIG. 9 is a flowchart of a method of pose prediction provided by the embodiments of the present application;

FIG. 10 is a structural schematic diagram of a pose prediction model provided by the embodiments of the present application;

FIG. 11 is a modular schematic diagram of an apparatus of pose prediction provided by the embodiments of the present application; and

FIG. 12 is a schematic block diagram of an electronic device provided by the embodiments of the present application.

### DETAILED DESCRIPTION

The following will provide a clear and complete description of the technical solution in the embodiments of the present application, in conjunction with the accompanying drawings. The described embodiments are only a part of the embodiments of the present application, not the entire embodiments. Based on the embodiments in the present application, all other embodiments obtained by those skilled in the art without creative labor fall within the scope of protection of the present application.

It should be noted that terms “first”, “second”, etc., in the specification of the present application and claims, as well as in the drawings, are used to distinguish similar objects, and do not necessarily need to be used to describe a specific order or sequence. It should be understood that the data used in this way may be interchanged in appropriate cases, so that the embodiments of the present application described herein may be implemented in order other than those illustrated or described herein. In addition, the terms “including” and “having” and any variations thereof are intended to cover non-exclusive inclusion, for example, a process, method, system, product, or server that includes a series of steps or units does not need to be limited to those clearly listed steps or units, but may include other steps or units that are not clearly listed or inherent to these processes, methods, products, or devices.

Before introducing the technical solution of the present application, the relevant knowledge of the present application is introduced first.
1. Artificial intelligence (AI), is a theory, a method, a technology, and an application system that uses digital computers or machines controlled by digital computers to simulate, extend, and expand human intelligence, and perceive environment to acquire knowledge and use the knowledge to achieve optimal results. In other words, AI is a comprehensive technology in computer science that attempts to understand the essence of intelligence and produce a new intelligent machine that may respond in a way similar to human intelligence. AI is the study of the design principles and implementation methods of various intelligent machines, enabling machines to have functions of perception, reasoning, and decision-making. AI technology is a comprehensive discipline that involves a wide range of fields, including both hardware and software level technologies. The basic technologies of AI generally include technologies such as sensors, specialized AI chips, cloud computing, distributed storage, big data processing technology, operation/interaction systems, and mechatronics integration. AI software technology mainly includes computer vision technology, speech processing technology, natural language processing technology, and machine learning/deep learning. The technical solutions provided in the present application mainly involve natural language processing technology in AI and machine learning/deep learning.
2. Long short-term neural networks, which are a basic network structure in contemporary neural networks, are classified as recurrent neural networks (RNN).

Usually, LSTM is used to extract temporal information. Compared to images and video, a single image does not have temporal information, while a video composed of consecutive images contains temporal information. In combination with the “motion capture” described in the present application, for pose in a single frame of a target object (such as a human body), there is no temporal information, but poses in a continuous plurality of frames of the target object contain temporal information. The present application uses LSTM to extract temporal information of the motion of the target object for the final motion capture.

In the related art, traditional action capture technologies based on deep learning models for end-to-end pose information acquisition typically use deep learning models that contain temporal structures (hereinafter referred to as models), such as temporal convolutional network (TCN), multilayer perceptron (MLP), Transformer, LSTM, and gated recurrent unit structure (GRU), etc.

For TCN, MLP and Transformer, a certain amount of cached historical frame data is typically required to predict a result of the current frame, which means using a fixed time window to cache the input data of historical frames. If the time window is set too short, it often cannot meet the high-precision model requirements. If the time window is set too long, it will bring extremely high computational and power costs, which are often unacceptable to mobile devices. And when combined with specific heterogeneous hardware, the above model structures often face the problem of complex model structure, unstable computing power on heterogeneous hardware platforms, and difficulty in deployment.

For structures like LSTM and GRU, only the hidden-state of the current frame is need to be cached after the inference of the current frame of the model is completed. In inference of the next frame, the hidden-state may be treated as input data and input together, which greatly reduces the computational costs of model inference. But when LSTM and GRU structures are combined with specific heterogeneous hardware, such as GPUs with high parallel computing power, LSTM or GRU is difficult to parallelize and efficiently utilize computing resources, resulting in a significant increase in model inference time.

To address the aforementioned technical problems, the present application provides method of pose prediction a method of pose prediction.

The following will first introduce the application scenario of the technical solution of the present application. As shown in FIG. 1, which is a schematic diagram of an application scenario of a method of pose prediction provided by the embodiments of the present application, the application scenario involves a terminal device 110 and a server 120, and the terminal device 110 may communicate with the server 120.

In some embodiments, the application scenario shown in FIG. 1 may also include: a base station, a core network side device, etc. In addition, FIG. 1 exemplarily illustrates one terminal device 110 and one server 120, which may actually include other numbers of terminal devices and servers. The embodiments of the present application are not limited to this.

In some embodiments, the server 120 in FIG. 1 may be an independent physical server, a cluster of multiple physical servers, or a distributed system. It may also be a cloud server providing basic cloud computing services such as cloud services, cloud databases, cloud computing, cloud functions, cloud storage, network services, cloud communication, middleware services, domain name services, security services, CDN, big data, and AI platforms, etc. There are no restrictions on this matter in the present application.

In some embodiments, the terminal device 110 shown in FIG. 1 may be equipped with an application client, which may interact with the server 120 for data when running in the terminal device 110. For example, the client here may specifically include: car client, smart home client, game client, multimedia client (such as video client), social client, and information client (such as news client).

In the embodiments of the present application, the terminal device 110 may be a kind of device with rich human-computer interaction modes, access to the Internet, usually equipped with various operating systems, and strong processing capabilities. The terminal device 110 may be smartphones, smart glasses, handheld terminals, smart TVs, tablet computers, car terminals, etc., but are not limited to these.

In an embodiment, the server 120 and the terminal device 110 may execute the method of pose prediction provided by the embodiments of the present application interactively, or the method of pose prediction provided by the embodiments of the present application may be executed by the terminal device 110.

The following will provide a detailed explanation of the technical solution of the present application.

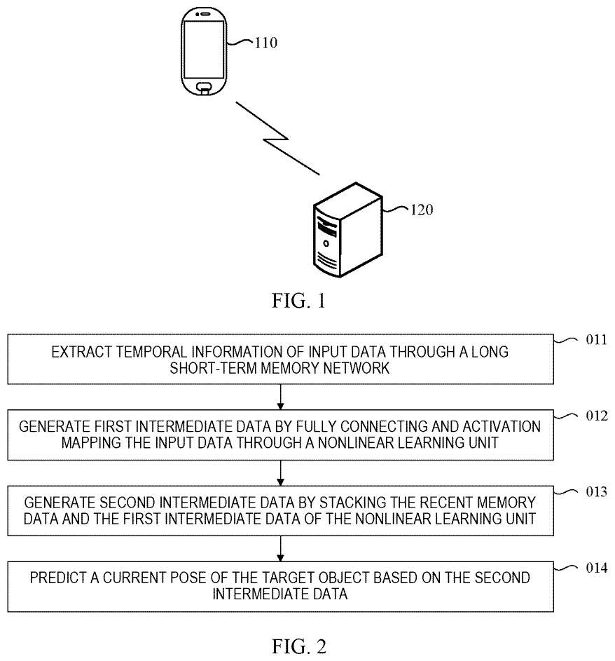

FIG. 2 is a flowchart of a method of pose prediction provided by the embodiments of the present application. The method may be executed by the terminal device 110 as shown in FIG. 1, but is not limited thereto. As shown in FIG. 2, the method may include the following steps.

Step 011: extracting temporal information of input data through a long short-term memory network 21, the temporal information including recent memory data, and the input data including pose data of a current frame of a target object collected by a pose sensor.

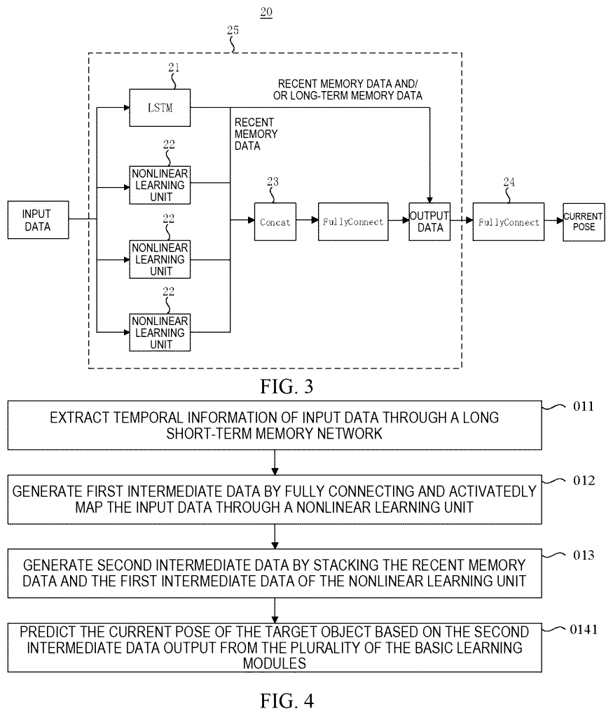

Referring to FIG. 3, after obtaining the input data, LSTM may be used to process the input data to extract temporal information from the input data, and the temporal information includes recent memory data and long-term memory data.

The recent memory data is also known as a hidden-state in LSTM, and the long-term memory data is also known as a cellular state in LSTM. The cellular state contains all long-term and short-term information, while the hidden-state is the information extracted from the cellular state that is most relevant to the current input.

The recent memory data and/or long-term memory data may be used as part of the input data for the next frame. In other words, the input data for the current frame includes not only the current frame pose data of the target object collected by the pose sensor, but generally also the recent memory data and/or long-term memory data extracted from the previous frame. For the first frame, since there is no previous frame, the input data may only include the pose data of the current frame.

The pose sensor may be an inertial measurement unit (IMU), a camera, etc. For example, if the pose sensor is the IMU and the target object is a human body, the IMU may be worn to different parts of the human body (such as the left wrist, right wrist, left knee, right knee, head, and waist). The pose information of the human body may be described by the rotation information of a plurality of segments of bones, and as a rigid body, the rotation information of any point on the skeleton is consistent. Therefore, the pose information of the human body may be characterized by the pose data collected by the IMUs of different parts of the human body. If the pose sensor is the camera and the target object is the human body, the camera captures images of the human body as the collected pose data.

By using LSTM to extract temporal information, the memory data of the previous frame may be used as part of the input data of the next frame. This not only reduces the computational costs of model inference, but also utilizes temporal information to achieve subsequent target object pose prediction, which is beneficial for improving the accuracy of pose prediction.

The functions used by LSTM for data processing are as follows:

$$[ \begin{matrix}{\tilde{i}}_{t} \\ {\tilde{f}}_{t} \\ {\tilde{a}}_{t} \\ {\tilde{o}}_{t}\end{matrix} ] = [ \begin{matrix}{W}_{xi} {X}_{t} + {W}_{hi} {X}_{t - 1} \\ {W}_{xf} {X}_{t} + {W}_{hf} {X}_{t - 1} \\ {W}_{xa} {X}_{t} + {W}_{ha} {X}_{t - 1} \\ {W}_{xo} {X}_{t} + {W}_{ho} {X}_{t - 1}\end{matrix} ] + [ \begin{matrix}{b}_{i} \\ {b}_{f} \\ {b}_{a} \\ {b}_{o}\end{matrix} ] , \qquad ( 1 )$$

$${c}_{t} = σ ( {o}_{t} ) ⊙ tanh ( {a}_{t} ) + σ ( {f}_{t} ) ⊙ {c}_{t - 1} , \qquad ( 2 )$$

$${h}_{t} = σ ( {o}_{t} ) ⊙ tanh ( {c}_{t} ) , \qquad ( 3 )$$

$${x}_{t} = [ {c}_{t - 1} , {x}_{input} ] , \qquad ( 4 )$$

where four Wₓ Wₕ and bᵢ all represent a weight matrix of the LSTM structure itself, which is a learnable parameter matrix; Xₜ represents the input data at time t (such as the current frame), Xᵢₙₚᵤₜ is the current frame pose data collected by the pose sensor. iₜ, fₜ, aₜ, and oₜ respectively represents the intermediate calculation results of LSTM at time t.

The output information of LSTM consists of two parts, namely hₜ and cₜ, hₜ, which are recent memory data, and Cₜ, which is long-term memory data; hₜ-represents the recent memory data extracted by LSTM at time (t−1), which means it is the recent memory data of the previous frame; cₜ₋₁ represents the extracted long-term memory data of LSTM at time (t−1).

σ is an activation function, such as Sigmoid activation function, tan h is a hyperbolic tangent function, and ⊙ is an element-wise multiplication operation. For example, in matrices A and B of the same size, after performing operation of ⊙, a matrix C of the same size is obtained. The element at the corresponding position in C is equal to the product of the element at the corresponding position in A and B.

Step 012: generating first intermediate data by fully connecting and activation mapping the input data through a nonlinear learning unit 22.

While extracting the temporal information of the input information through LSTM, it is also necessary to extract features from the input data for pose prediction. The Nonlinear learning unit 22 may process input data in parallel with LSTM, perform fully connection and activation mapping on the input data, and generate the first intermediate data.

The nonlinear learning unit 22 may also normalize the input data, which may be layer normalization achieved through a LayerNorm operator. Layer normalization may ensure the smoothness of the model training. A fully connected layer contains most of the learnable parameters, which may be used for matrix operations, and linear mapping of the input data may be achieved through a FullyConnect operator. Activation mapping introduces nonlinear factors into the model through activation functions, such as Elu or Relu functions. Elu function is usually supported on a large portion of heterogeneous hardware platforms (i.e., electronic devices), and Relu function is supported on all heterogeneous hardware platforms in the market.

The calculation process of LayerNorm, FullyConnect, and Elu/Relu is expressed as a function below:

$${k}_{t}^{i} = {F}^{i} ( {x}_{t} ) , i = 1 , 2 , 3 , … , n . \qquad ( 5 )$$

Due to the fact that normalization, full connection, and activation mapping are only matrix multiplication and/or addition, any heterogeneous hardware platform may support matrix multiplication and addition, allowing the nonlinear learning unit 22 to adapt to any heterogeneous hardware platform. By combining the widely used LSTM and nonlinear learning unit 22 to achieve current pose prediction, the model has good adaptability to different heterogeneous hardware platforms, without the need to adjust the model adaptively based on specific heterogeneous hardware platforms. The deployment costs are low, and universal deployment may be achieved.

In addition, due to the ability of the nonlinear learning unit 22 to introduce nonlinear factors, processing input data through the nonlinear learning unit 22 is beneficial for improving the fitting ability of the model during the training. Therefore, the more nonlinear learning units 22 parallel to LSTM, the stronger of the fitting ability of the model.

The nonlinear unit may normalize, fully connect, and activation mapping the input data sequentially to generate the first intermediate data. By normalizing first, a better gradient expression for the model may be provided, which is beneficial for the stationarity of the model training.

The number of nonlinear learning units 22 that process input data in parallel with LSTM may be one or more.

For traditional heterogeneous hardware platforms (such as the terminal device 110), the parallel capability is generally greater than 4. Therefore, the number of nonlinear learning units 22 may be set to 3, in order to maximize the parallel capability of the hardware platform and improve model performance, while ensuring that the model may adapt to any current heterogeneous hardware platform as much as possible.

LSTM or GRU will inevitably cause an accuracy loss error. The accuracy loss error comes from converting a data calculation mode from FLOAT32 to FLOAT16, or INT8 and INT16. A timing accumulation error are mainly caused by the need to maintain the hidden-state in the model during continuous frame inference, which means that the hidden-state of the previous frame will become the model input of the next frame. As time accumulates, the calculation results of heterogeneous hardware will inevitably have accuracy errors, leading to an increase in timing accumulation error.

In the embodiments of the present application, due to the parallel processing of LSTM and the nonlinear learning unit 22, the number of LSTM may be reduced. Compared to setting a plurality of LSTMs, the complex structure of LSTM leads to a large resource occupation, and the accuracy loss error and temporal accumulation error of LSTM are relatively large. When using LSTM and nonlinear learning unit 22 to process input data in parallel, the data processing and structure of the nonlinear learning unit 22 are relatively simple. Therefore, the model of the present application has less resource occupation and smaller error for data processing, which is conducive to improving the accuracy of subsequent pose prediction.

Step 013: generating second intermediate data by stacking the recent memory data and the first intermediate data of the nonlinear learning unit 22 through a stacked unit 23, the long short-term memory network 21, the nonlinear learning unit 22, and the stacked unit 23 forming a basic learning module 25.

After LSTM extracts the recent memory data from the input data and the first intermediate data generated from the nonlinear learning unit 22, the recent memory data and the first intermediate data may be stacked to generate the second intermediate data.

Stacking may be axial stacking (Concat operation) or add operation.

The Concat operation does not add, but simply fuses features output by different structures, i.e., a plurality of matrices, into a larger matrix. The number of channels in the matrix increases, while the information under each feature is not stacked; when heterogeneous hardware platforms need to perform calculations in FLOAT16 or INT8 data formats, compared to the add operation, the Concat operation has almost no quantization accuracy error and does not generate numerical overflow errors.

The add operation involves adding a plurality of matrices element by element, forming a matrix of the same size as an input matrix. The amount of information under each feature increases, but the number of channels does not increase. The add operation is beneficial for improving the accuracy of classification.

After stacking the recent memory data and the first intermediate data, the stacked data may be fully connected (as shown in FullyConnect in FIG. 3) to perform dimension transformation, thereby generating the second intermediate data. The calculation process of dimension transformation is expressed as the following function:

$${d}_{t} = D ( {x}_{t} ) \qquad ( 6 )$$

It may be understood that xt in function (6) represents the stacked data, rather than the input data mentioned earlier.

The calculation process of generating the second intermediate data pₜ based on the input data is expressed as the following function:

$${p}_{t} = D ( [ {h}_{t} , {k}_{t}^{1} , {k}_{t}^{2} , {k}_{t}^{3} , … , {k}_{t}^{n} ] ) . \qquad ( 7 )$$

That is to say, LSTM extracts and obtains hₜ, and one or more nonlinear learning units 22 respectively obtain k₁^{t}, kₜ², kₜ³, . . . , kₜⁿ, and then hₜ, k₁^{t}, kₜ², kₜ³, . . . , kₜⁿ are stacked and subjected to dimensional transformation to ultimately generate the second intermediate data pₜ.

Step 014: predicting a current pose of the target object based on the second intermediate data.

The model includes one or more neural network structures (such as FullyConnect) that output the final desired result, each of the neural network structures may perform different prediction tasks. After obtaining the second intermediate data, the second intermediate data may be input into the neural network structure to output the final result. If the neural network structure may predict the type of the target object, the neural network structure may output the type of the target object based on the second intermediate data; alternatively, if the neural network structure may predict the current pose of the target object, the neural network structure may output the current pose of the target object based on the second intermediate data.

In the embodiments of the present application, at least a neural network structure capable of predicting the current pose of the target object is included, in order to predict the current pose of the target object based on the second intermediate data.

The method of pose prediction provided by this embodiment utilizes the long short-term memory network 21 to extract temporal information from the input data. The input data not only includes the current frame pose data collected by the pose sensor, but also the long-term memory data extracted from the previous frame. Afterwards, the recent memory data in the current frame and the first intermediate data learned by the nonlinear learning unit 22 in the input data are stacked to obtain the second intermediate data for predicting the current pose. Due to the consideration of temporal information when predicting the current pose of the target object, it is beneficial to improve the accuracy of the current pose prediction. Moreover, due to the fact that the nonlinear learning unit 22 processes input data through full connection and activation mapping, which only require matrix multiplication and/or addition, the nonlinear learning unit 22 may adapt to any heterogeneous hardware platform. Then, combining the nonlinear learning unit 22 with models constructed by LSTM, which is widely used, to achieve the prediction of the current pose, not only ensures the prediction accuracy of the current pose, but also makes the model more adaptable to different heterogeneous hardware platforms, without the need to adjust the model according to specific heterogeneous hardware platforms. The deployment costs are low, and universal deployment may be achieved.

In addition, building models based on LSTM and the nonlinear learning unit 22 may reduce computational costs (such as resource usage in data processing), facilitate deployment on different heterogeneous hardware platforms, efficiently utilize parallel computing capabilities of heterogeneous hardware platforms, and alleviate the accuracy loss error and the temporal accumulation error caused by LSTM structures.

Referring to FIG. 4, in some embodiments, the step 014: predicting a current pose of the target object based on the second intermediate data includes:
step 0141: predicting the current pose of the target object based on the second intermediate data output from the plurality of the basic learning modules 25.

The long short-term memory network 21, the nonlinear learning unit 22, and the stacked unit 23 may form the basic learning module 25. A plurality of basic learning modules 25 may be provided, and each basic learning module 25 may generate corresponding second intermediate data after steps 011-013. When predicting the current pose of the target object, the second intermediate data output by the plurality of the basic learning modules 25 may be used to predict the current pose of the target object. This may further improve the accuracy of pose prediction.

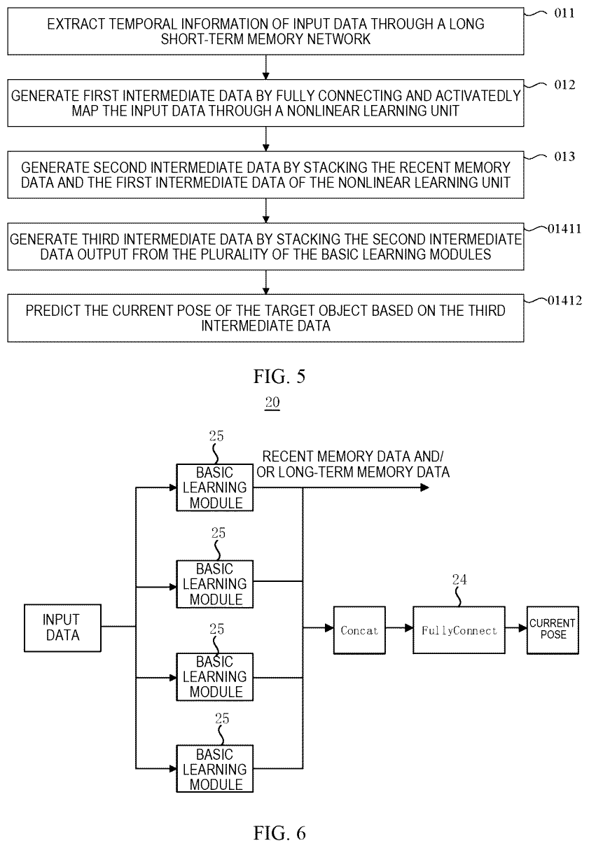

Referring to FIG. 5, in some embodiments, step 0141: predicting the current pose of the target object based on the second intermediate data output from the plurality of the basic learning modules 25 includes:
step 01411: generating third intermediate data by stacking the second intermediate data output from the plurality of the basic learning modules 25; and
step 01412: predicting the current pose of the target object based on the third intermediate data.

In conjunction with FIG. 6, in order to better utilize the parallel capabilities of heterogeneous hardware platforms (such as heterogeneous hardware platforms including a plurality of processors, each with parallel capability), a plurality of the basic learning modules 25 may be parallelized to form a horizontally scalable structure. For example, each basic learning module 25 is deployed with a processor, and then LSTM and the nonlinear learning unit 22 are executed in parallel within the processor, so that each basic learning module 25 may output the corresponding second intermediate data.

Afterwards, when using the second intermediate data output by the plurality of the basic learning modules 25 to predict the current pose of the target object, the second intermediate data output by the plurality of basic learning modules 25 may be stacked to generate the third intermediate data. The stacked unit 23 may stack axially to use the third intermediate data containing more channels to predict the current pose of the target object and improve the accuracy of pose prediction.

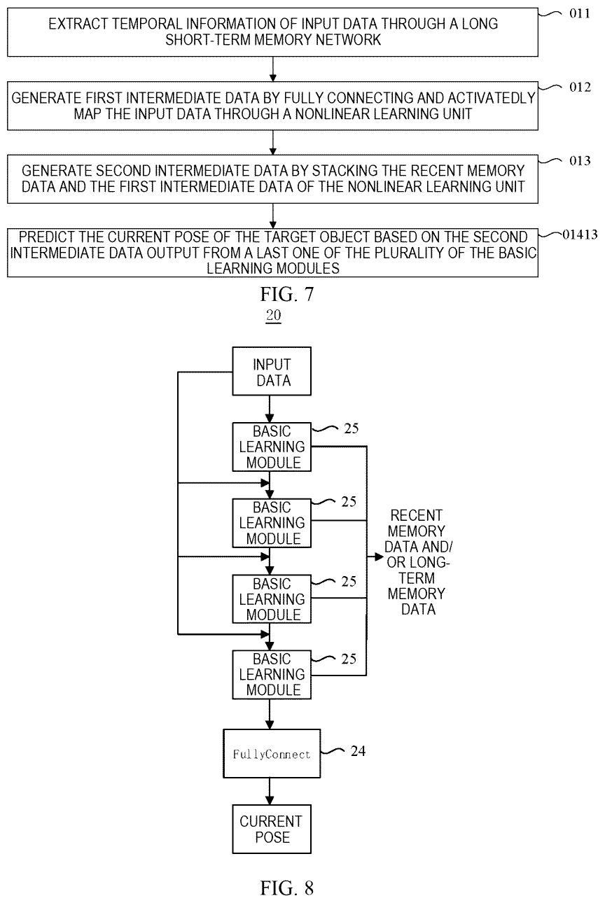

Referring to FIG. 7, in some embodiments, step 0141: predicting the current pose of the target object based on the second intermediate data output from the plurality of the basic learning modules 25 includes:
step 01413: predicting the current pose of the target object based on the second intermediate data output from a last one of the plurality of the basic learning modules 25.

Referring to FIG. 8, in some low bit computing hardware platforms, such as hardware platforms computing in INT8 or INT12 data formats, the model will have serious quantization errors during the calculation process. The quantization error will not only be transmitted in the model, but also in the temporal structure.

Therefore, a plurality of the basic learning modules 25 may be connected in series (i.e. a plurality of basic learning modules 25 are sequentially connected) to form a longitudinal extension structure, so that the output of the previous basic learning module 25 serves as the input of the subsequent basic learning module 25.

In a case where the depth of the longitudinal extension structure is not deep, even if the input data of the basic learning module 25 is not stacked (i.e., the current frame pose data of the target object collected by the pose sensor and the input data of the short-term and/or long-term memory data extracted by the long short-term memory network 21 in the previous frame mentioned earlier), the quantization error brought is also relatively small. However, in deep cases, it is necessary to stack the input data of each basic learning module 25 (such as axial stacking) with the output of the previous basic learning module 25, in order to reduce the quantization error.

Finally, the current pose of the target object is predicted based on the second intermediate data output from the last one of the basic learning module 25. This ensures that even with an increase in model depth, the gradients during model training may be well transmitted. By combining a plurality of the basic learning modules 25 in a series stacked manner, the generalization performance of the model may be further improved, and the noise resistance of the model may be enhanced. This may significantly reduce the quantization error caused by low bit calculations, and the LSTM and nonlinear learning unit 22 in each basic module may still be executed in parallel, effectively utilizing the parallel capabilities of heterogeneous hardware platforms.

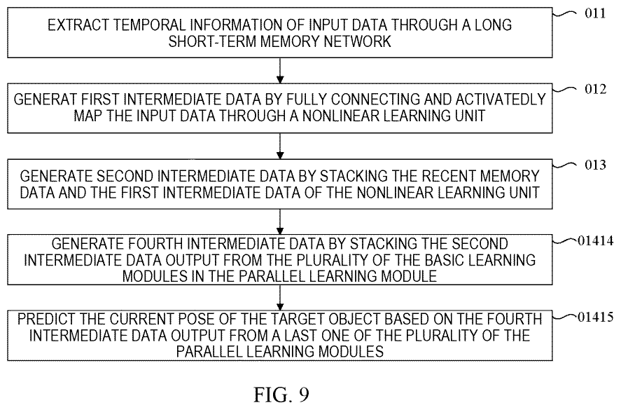

Referring to FIG. 9, in some embodiments, step 0141: predicting the current pose of the target object based on the second intermediate data output from the plurality of the basic learning modules 25 includes:
Step 01414: generating fourth intermediate data by stacking the second intermediate data output from the plurality of the basic learning modules 25 in the parallel learning module 26; and
Step 01415: predicting the current pose of the target object based on the fourth intermediate data output from a last one of the plurality of the parallel learning modules 26.

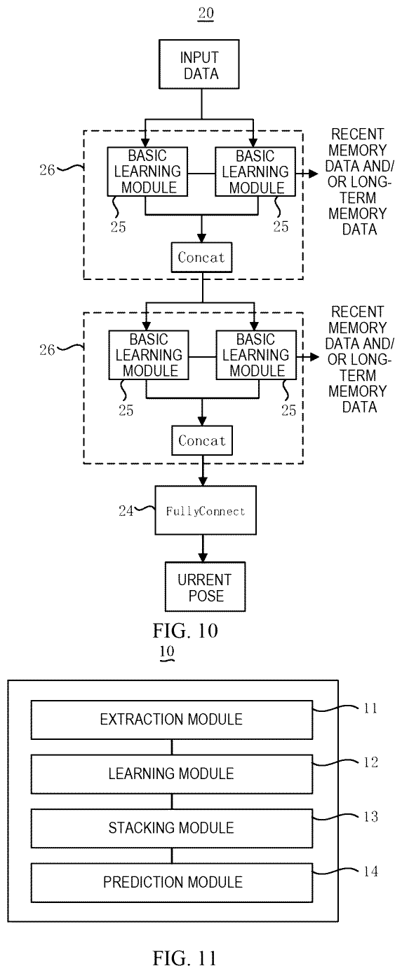

Referring to FIG. 10, as mentioned earlier, the horizontal expansion structure better utilizes the parallel capability of heterogeneous hardware platforms, while the longitudinal extension structure may reduce the model quantization error of low bit computing heterogeneous hardware platforms. Therefore, the combination of horizontal expansion and longitudinal extension structures may better utilize the parallel capability of heterogeneous hardware platforms while reducing the model quantization error of low bit computing heterogeneous hardware platforms.

A plurality of the basic learning modules 25 form the parallel learning module 26, which implements the horizontal expansion structure. By stacking the second intermediate data output by the plurality of basic learning modules 25 of the parallel learning module 26, the fourth intermediate data is generated.

There are also a plurality of the parallel learning modules 26, which are then sequentially connected to form the longitudinal extension structure. The output of the previous parallel learning module 26 serves as the input of the subsequent parallel learning module 26.

In a case where the depth of the longitudinal extension structure is not deep, even if the input of the parallel learning module 26 is not stacked with the input data (i.e., the current frame pose data of the target object collected by the pose sensor and the input data of the short-term and/or long-term memory data extracted by the long short-term memory network 21 in the previous frame mentioned earlier), there are few quantization errors. However, in deep cases, it is necessary to stack the input data of each parallel learning module 26 (such as axial stacking) with the output of the previous parallel learning module 26, in order to reduce quantization errors.

Therefore, the fourth intermediate data output by the previous parallel learning module 26 will serve as the input for the next parallel learning module 26. Therefore, when a plurality of parallel learning modules 26 are combined in a series stacked manner, the generalization performance of the model may be further improved and noise resistance enhanced, significantly reducing quantization errors caused by low bit computing.

Referring to FIG. 11, the method of pose prediction of the present application may be performed through an apparatus of pose prediction 10, which includes an extraction module 11, a learning module 12, a stacking module 13, and a prediction module 14. The extraction module 11 is configured to extract temporal information of input data through a long short-term memory network 21, the temporal information including recent memory data, and the input data including pose data of a current frame of a target object collected by an inertial measurement unit; the learning module 12 is configured to generate first intermediate data by fully connecting and activation mapping the input data through a nonlinear learning unit 22; the stacking module 13 is configured to generate second intermediate data by stacking the recent memory data and the first intermediate data of the nonlinear learning unit 22 through a stacked unit 23, the long short-term memory network 21, the nonlinear learning unit 22, and the stacked unit 23 forming a basic learning module 25; and the prediction module 14 is configured to predict a current pose of the target object based on the second intermediate data.

The prediction module 14 is further configured to predict the current pose of the target object based on the second intermediate data output from the plurality of the basic learning modules 25.

The prediction module 14 is further configured to generate third intermediate data by stacking the second intermediate data output from the plurality of the basic learning modules 25, and predict the current pose of the target object based on the third intermediate data.

The prediction module 14 is further configured to predict the current pose of the target object based on the second intermediate data output from a last one of the plurality of the basic learning modules 25.

The prediction module 14 is further configured to generate fourth intermediate data by stacking the second intermediate data output from the plurality of the basic learning modules 25 in the parallel learning module 26, and predict the current pose of the target object based on the fourth intermediate data output from a last one of the plurality of the parallel learning modules 26.

The learning module 12 is further configured to generate the first intermediate data by normalizing, fully connecting, and activation mapping the input data sequentially through the nonlinear learning unit 22.

The apparatus of pose prediction 10 is described above from the perspective of a functional module, which may be implemented in hardware, software instructions, or a combination of hardware and software modules. The steps of the method embodiments in the present application may be implemented through integrated logic circuits and/or software instructions in hardware of a processor. The steps of the method disclosed in the present application may be directly reflected in the execution of the hardware encoding processor or the combination of hardware and software modules in the encoding processor. Software modules may be located in mature storage media in the field, such as random access memory, flash memory, read-only memory, programmable read-only memory, electrically erasable programmable memory, registers, etc. The storage medium is located in the memory, and the processor reads the information in the memory and combines it with its hardware to complete the steps in the above method embodiments.

Referring to FIG. 3 again, which is a structural schematic diagram of a pose prediction model provided by the embodiments of the present application. The pose prediction model 20 may be deployed to an electronic device, enabling the electronic device to implement any one of the aforementioned methods of pose prediction.

The pose prediction model 20 includes a long short-term memory network 21, a nonlinear learning unit 22, a stacked unit 23, and a prediction unit 24. The long short-term memory network 21 is configured to extract temporal information of input data, the temporal information including recent memory data, and the input data including pose data of a current frame of a target object collected by an inertial measurement unit; the nonlinear learning unit 22 is configured to generate first intermediate data by fully connecting and activation mapping the input data, and generate second intermediate data by stacking the recent memory data and the first intermediate data of the nonlinear learning unit 22, the long short-term memory network 21, the nonlinear learning unit 22, and the stacked unit 23 forming a basic learning module 25; and the prediction unit 24 is configured to predict the current pose of the target object based on the second intermediate data.

The long short-term memory network 21 is connected in parallel with the nonlinear learning unit 22 to achieve parallel processing. The recent memory data extracted by the nonlinear learning unit 22 and the first intermediate data learned by the nonlinear learning unit 22 are stacked by the stacked unit 23 to generate the second intermediate data, which is then input into the prediction unit 24. The prediction unit 24 may predict and output the current pose of the target object based on the second intermediate data. The details are referred to the description of step 011 to step 014 for details, which will not be repeated here.

Referring to FIG. 6 and FIG. 8 again, the pose prediction model 20 includes a plurality of basic learning modules 25; the prediction unit 24 is further configured to predict the current pose of the target object based on the second intermediate data output from the plurality of the basic learning modules 25.

The plurality of the basic learning modules 25 are connected in parallel to form the aforementioned horizontal expansion structure (referring step 01411 and step 01412 for details); alternatively, the plurality of basic learning modules 25 may be connected in series to form the aforementioned longitudinal extension structure (referring step 01413 for details).

Referring to FIG. 10 again, the pose prediction model 20 includes a plurality of parallel learning modules 26, each of which includes a plurality of parallel basic learning modules 25. The plurality of parallel basic learning modules 25 in each parallel learning module 26 form the aforementioned horizontal expansion structure (referring step 01414 for details); a plurality of parallel learning modules 26 are connected in series to form the aforementioned longitudinal extension structure (referring step 01415 for details)

The number of the basic learning modules 25 is 2 or 4.

The more stacked the number of basic learning modules 25, the higher the overall computational complexity, and the higher the parallel computing power required for heterogeneous hardware platforms. The parallel computing power of heterogeneous hardware platforms determines the upper limit of parallelism. For example, if an electronic device includes four processors, and one processor may support one basic learning module 25. Even if 12 basic learning modules 25 are stacked, the four basic learning models are still grouped together, divided into three groups, and executed in parallel within the same group, while different groups are executed in series. And currently, the parallel capability of the electronic device is generally even, such as electronic device including 2 processors, 4 processors, 8 processors, etc. The number of the basic learning modules 25 is 2 or 4, which may ensure the full utilization of the parallel capability of the electronic device, and the overall required computational amount is also relatively small.

The nonlinear learning unit 22 includes a normalization operator, a full connection operator, and an activation operator. The normalization operator is configured to normalize the input data, the full connection operator is configured to perform a full connection operation on the normalized data, and the activation operator is configured to perform activation mapping on the fully connected data through a pre-determined activation function to generate the first intermediate data.

The pose prediction model 20 includes the LSTM, the normalization operator, the full connection operator, the activation operator, and a stacking operator, etc. It has a simple structure and is widely used, all of which may adapt to various hardware platforms, ensuring that the pose prediction model 20 may be widely deployed on heterogeneous hardware platforms and may be deployed on a plurality of ends, significantly reducing deployment costs. By implementing parallel execution of the nonlinear learning unit 22 and LSTM, a plurality of basic learning units may achieve horizontal expansion and/or longitudinal extension structures, enabling the pose prediction model 20 to fully utilize the parallel capabilities of heterogeneous hardware platforms while reducing the errors that LSTM may cause during inference on heterogeneous hardware.

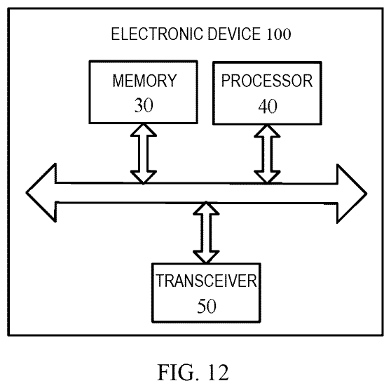

FIG. 12 is a schematic block diagram of an electronic device provided by the embodiments of the present application. The electronic device 100 may be a terminal device 110 or a server 120 in the above-mentioned method embodiments.

As shown in FIG. 12, the electronic device 100 may include:
a memory 30 and a processor 40, and the memory 30 is used to store a computer program and transfer a code of the program to the processor 40. In other words, the processor 40 may call and run the computer program from the memory 30 to implement a method in any one of the embodiments of the present application.

In some embodiments of the present application, the processor 40 may include but is not limited to:
a universal processor, a digital signal processor (DSP), an application specific integrated circuit (ASIC), a field programmable gate array (FPGA), or other programmable logic devices, discrete gate or transistor logic devices, discrete hardware components, etc.

In some embodiments of the present application, the memory 30 includes but is not limited to:
a volatile memory and/or a non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some embodiments of the present application, the computer program may be divided into one or more modules, which are stored in the memory 30 and executed by the processor 40 to complete the methods provided in the present application. The one or more modules may be a series of computer program instruction segments capable of performing specific functions, which are used to describe the execution process of the computer program in the electronic device 100.

As shown in FIG. 12, the electronic device 100 may further include:
a transceiver 50, which may be connected to the processor 40 or the memory 30.

The processor 40 may control the transceiver 50 to communicate with other devices.

Information or data may be sent to other devices, or received from other devices, such as receiving pose data collected by pose sensors set on the target object through the transceiver 50. The transceiver 50 may include a transmitter and a receiver. The transceiver 50 may further include an antenna, and the number of antennas may be one or more.

It should be understood that the various components in the electronic device 100 are connected through a bus system, which includes not only a data bus, but also a power bus, a control bus, and a status signal bus.

The present application also provides a computer storage medium on which a computer program is stored, and the computer program, when executed by a computer, enables the computer to execute the above-mentioned method embodiments. Or, in other words, the present application also provides a computer program product containing instructions, which, when executed by a computer, causes the computer to execute the above-mentioned method embodiments.

When implemented by software, the present application may be fully or partially implemented in the form of a computer program product including one or more computer instructions. When loading and executing the computer program instructions on the computer, all or part of the processes or functions according to the embodiments of the present application are generated. The computer may be a general-purpose computer, a specialized computer, a computer network, or other programmable devices. The computer instruction may be stored in a computer-readable storage medium or transmitted from one computer-readable storage medium to another, for example, the computer instruction may be transmitted from a website, a computer, a server, or a data center via wired (such as coaxial cable, fiber optic cable, digital subscriber line, etc.), digital subscriber line (DSL) or wireless (such as infrared, wireless, microwave, etc.) transmission to another website, computer, server, or data center. The computer-readable storage medium may be any available medium that the computer may access, or a data storage device such as a server, a data center, etc. that integrates one or more available media. The available media may be magnetic media (such as a floppy disk, a hard drive, and a magnetic tape), optical media (such as a digital video disk (DVD)), or semiconductor media (such as a solid state disk (SSD)), etc.

Those of ordinary skill in the art may realize that combining the modules and algorithm steps described in the embodiments disclosed in the present application may be achieved through electronic hardware, or a combination of computer software and electronic hardware. Whether these functions are executed in hardware or software depends on the specific application and design constraints of the technical solution. Professional technicians may use different methods to achieve the described functions for each specific application, but such implementation should not be considered beyond the scope of the present application.

In the several embodiments provided in the present application, it should be understood that the disclosed systems, apparatuses, and methods may be implemented in other ways. For example, the apparatus embodiments described above are only illustrative. For example, the division of the module is only a logical function division, and there may be other division methods in actual implementation, for example, a plurality of modules or components may be combined or integrated into another system, or some features may be ignored or not executed. Another point is that the coupling or direct coupling or communication connection displayed or discussed between each other may be indirect coupling or communication connection through some interfaces, devices or modules, which may be in the form of electrical, mechanical or others.

The modules used as separate components may be or may not be physically separated, while the components displayed as modules may be or may not be physical modules, which may be located in one place or distributed across a plurality of network units. Some or all modules may be selected according to actual needs to achieve the purpose of this embodiment. For example, in the present application, each functional module in each embodiment may be integrated into one processing module, each module may exist physically separately, or two or more modules may be integrated into one module.

The above are only the specific embodiments of the present application, but the scope of protection of the present application is not limited to this. Those changes or replacements within the scope of technology disclosed in the present application that may be easily thought of by those skilled in the art should be covered within the scope of protection of the present application. Therefore, the protection scope of the present application should be based on the protection scope of the claims.

1. A method of pose prediction, comprising:
extracting temporal information of input data through a long short-term memory network, the temporal information comprising recent memory data, and the input data comprising pose data of a current frame of a target object collected by a pose sensor;
generating first intermediate data by fully connecting and activation mapping the input data through a nonlinear learning unit;
generating second intermediate data by stacking the recent memory data and the first intermediate data of the nonlinear learning unit through a stacked unit, the long short-term memory network, the nonlinear learning unit, and the stacked unit forming a basic learning module; and
predicting a current pose of the target object based on the second intermediate data.

2. The method of pose prediction of claim 1, wherein there are a plurality of the basic learning modules, and the predicting the current pose of the target object based on the second intermediate data comprises:
predicting the current pose of the target object based on the second intermediate data output from the plurality of the basic learning modules.

3. The method of pose prediction of claim 2, wherein the predicting the current pose of the target object based on the second intermediate data output from the plurality of the basic learning modules comprises a plurality of:
generating third intermediate data by stacking the second intermediate data output from the plurality of the basic learning modules; and
predicting the current pose of the target object based on the third intermediate data.

4. The method of pose prediction of claim 2, wherein the plurality of a plurality of the basic learning modules are sequentially connected, an output of a previous basic learning module is used as an input of a subsequent basic learning module, and the predicting the current pose of the target object based on the second intermediate data output from the plurality of the basic learning modules comprises a plurality of:
predicting the current pose of the target object based on the second intermediate data output from a last one of the plurality of the basic learning modules.

5. The method of pose prediction of claim 2, wherein a plurality of the plurality of the basic learning modules form a parallel learning module, there are a plurality of parallel learning modules, a plurality of and the plurality of the parallel learning modules are sequentially connected, an output of a previous parallel learning module is used as an input of a subsequent parallel learning module, and the predicting the current pose of the target object based on the second intermediate data output from the plurality of the basic learning modules comprises a plurality of:
generating fourth intermediate data by stacking the second intermediate data output from the plurality of the basic learning modules in the parallel learning module; and
predicting the current pose of the target object based on the fourth intermediate data output from a last one of the plurality of the parallel learning modules.

6. The method of pose prediction of claim 1, wherein the stacked unit stacks the recent memory data and the first intermediate data through axial stacking.

7. The method of pose prediction of claim 1, wherein the generating the first intermediate data by fully connecting and activation mapping the input data through the nonlinear learning unit comprises:
generating the first intermediate data by normalizing, fully connecting, and activation mapping the input data sequentially through the nonlinear learning unit.

8. An electronic device, comprising:
a memory, a processor, and a computer program stored in the memory and capable of running on the processor, the processor, when executing the program,
causing the electronic device to perform acts comprising:
extracting temporal information of input data through a long short-term memory network, the temporal information comprising recent memory data, and the input data comprising pose data of a current frame of a target object collected by a pose sensor;
generating first intermediate data by fully connecting and activation mapping the input data through a nonlinear learning unit;
generating second intermediate data by stacking the recent memory data and the first intermediate data of the nonlinear learning unit through a stacked unit, the long short-term memory network, the nonlinear learning unit, and the stacked unit forming a basic learning module; and
predicting a current pose of the target object based on the second intermediate data.

9. The electronic device of claim 8, wherein there are a plurality of the basic learning modules, and the predicting the current pose of the target object based on the second intermediate data comprises:
predicting the current pose of the target object based on the second intermediate data output from the plurality of the basic learning modules.

10. The electronic device of claim 9, wherein the predicting the current pose of the target object based on the second intermediate data output from the plurality of the basic learning modules comprises a plurality of:
generating third intermediate data by stacking the second intermediate data output from the plurality of the basic learning modules; and
predicting the current pose of the target object based on the third intermediate data.

11. The electronic device of claim 9, wherein the plurality of a plurality of the basic learning modules are sequentially connected, an output of a previous basic learning module is used as an input of a subsequent basic learning module, and the predicting the current pose of the target object based on the second intermediate data output from the plurality of the basic learning modules comprises a plurality of:
predicting the current pose of the target object based on the second intermediate data output from a last one of the plurality of the basic learning modules.

12. The electronic device of claim 9, wherein a plurality of the plurality of the basic learning modules form a parallel learning module, there are a plurality of parallel learning modules, a plurality of and the plurality of the parallel learning modules are sequentially connected, an output of a previous parallel learning module is used as an input of a subsequent parallel learning module, and the predicting the current pose of the target object based on the second intermediate data output from the plurality of the basic learning modules comprises a plurality of:
generating fourth intermediate data by stacking the second intermediate data output from the plurality of the basic learning modules in the parallel learning module; and
predicting the current pose of the target object based on the fourth intermediate data output from a last one of the plurality of the parallel learning modules.

13. The electronic device of claim 8, wherein the stacked unit stacks the recent memory data and the first intermediate data through axial stacking.

14. The electronic device of claim 8, wherein the generating the first intermediate data by fully connecting and activation mapping the input data through the nonlinear learning unit comprises:
generating the first intermediate data by normalizing, fully connecting, and activation mapping the input data sequentially through the nonlinear learning unit.

15. A non-transitory computer-readable storage medium, comprising a computer program which, when executed by a processor, causes the processor to implementing acts comprising:
extracting temporal information of input data through a long short-term memory network, the temporal information comprising recent memory data, and the input data comprising pose data of a current frame of a target object collected by a pose sensor;
generating first intermediate data by fully connecting and activation mapping the input data through a nonlinear learning unit;
generating second intermediate data by stacking the recent memory data and the first intermediate data of the nonlinear learning unit through a stacked unit, the long short-term memory network, the nonlinear learning unit, and the stacked unit forming a basic learning module; and
predicting a current pose of the target object based on the second intermediate data.

16. The non-transitory computer-readable storage medium of claim 15, wherein there are a plurality of the basic learning modules, and the predicting the current pose of the target object based on the second intermediate data comprises:
predicting the current pose of the target object based on the second intermediate data output from the plurality of the basic learning modules.

17. The non-transitory computer-readable storage medium of claim 16, wherein the predicting the current pose of the target object based on the second intermediate data output from the plurality of the basic learning modules comprises a plurality of:
generating third intermediate data by stacking the second intermediate data output from the plurality of the basic learning modules; and
predicting the current pose of the target object based on the third intermediate data.

18. The non-transitory computer-readable storage medium of claim 16, wherein the plurality of a plurality of the basic learning modules are sequentially connected, an output of a previous basic learning module is used as an input of a subsequent basic learning module, and the predicting the current pose of the target object based on the second intermediate data output from the plurality of the basic learning modules comprises a plurality of:
predicting the current pose of the target object based on the second intermediate data output from a last one of the plurality of the basic learning modules.

19. The non-transitory computer-readable storage medium of claim 16, wherein a plurality of the plurality of the basic learning modules form a parallel learning module, there are a plurality of parallel learning modules, a plurality of and the plurality of the parallel learning modules are sequentially connected, an output of a previous parallel learning module is used as an input of a subsequent parallel learning module, and the predicting the current pose of the target object based on the second intermediate data output from the plurality of the basic learning modules comprises a plurality of:
generating fourth intermediate data by stacking the second intermediate data output from the plurality of the basic learning modules in the parallel learning module; and
predicting the current pose of the target object based on the fourth intermediate data output from a last one of the plurality of the parallel learning modules.

20. The non-transitory computer-readable storage medium of claim 15, wherein the stacked unit stacks the recent memory data and the first intermediate data through axial stacking.
